(19) United States
(12) Patent Application Publication
(10) Pub. No.: US 2014/0259155 A1
(43) Pub. Date: Sep. 11, 2014

(54) PROCESS AUTHENTICATION METHOD AND ELECTRONIC DEVICE IMPLEMENTING THE SAME

(71) Applicant: Samsung Electronics Co., Ltd., Suwon-si (KR)

(72) Inventor: Jungyoon KIM, Seoul (KR)

(73) Assignee: Samsung Electronics Co., Ltd., Suwon-si (KR)

(21) Appl. No.: 14/196,446

(22) Filed: Mar. 4, 2014

(30) Foreign Application Priority Data
Mar. 11, 2013 (KR) 10-2013-0025641

(51) Int. Cl. G06F 21/44

(52) U.S. Cl. CPC G06F 21/44
USPC 726/19

(57) ABSTRACT

A method and a device for authenticating a process in a computing device allowing an application loaded into a memory to operate as a process are provided. The method includes receiving a message requesting authentication of the process, acquiring unique information of the process from an operating system of the process in response to the message requesting authentication of the process, comparing the acquired unique information with unique information previously stored in a memory, and determining that the authentication of the process has succeeded, when the acquired unique information coincides with the unique information previously stored.

### CROSS-REFERENCE TO RELATED APPLICATION(S)

This application claims the benefit under 35 U.S.C. §119(a) of a Korean patent application filed on Mar. 11, 2013 in the Korean Intellectual Property Office and assigned Serial number 10-2013-0025641, the entire disclosure of which is hereby incorporated by reference.

### TECHNICAL FIELD

The present disclosure relates to a method and a device for authenticating a process. More particularly, the present disclosure relates to a method and a device for authenticating a process in a computing device allowing an application loaded into a memory to operate as a process.

### BACKGROUND

An application operates as a process, while being loaded into a memory (e.g., being loaded from a hard disk into the memory). Namely, the running application may be regarded as the process. Such a process needs to be authenticated. For example, when an application is loaded into a memory, an authentication procedure is performed to determine whether the corresponding application is an authorized entity. Further, when a process requests access to data or another application from an operating system, the operating system may perform an authentication procedure for the corresponding process. The authentication procedure may be generally performed as follows.

An electronic signature is created in advance and preserved (stored). When an application is loaded into a memory, an execution file of the corresponding application is acquired. For example, an F (execution file) is calculated. Here, the F ( ) is an arbitrary function. For example, the F ( ) may be a hash function. The electronic signature is compared with a result value (=F (execution file)). If the two values coincide with each other as a result of the comparison, the authentication succeeds and the corresponding process may accordingly read data. On the other hand, if the two values do not coincide with each other, the authentication fails and the corresponding process cannot read the data. Namely, access to data is rejected by the operating system.

Accordingly, a process authentication method and an electronic device implementing the same, which may provide swift process authentication, thereby enabling a substantial service, and improving an application quality in terms of usability is desired.

The above information is presented as background information only to assist with an understanding of the present disclosure. No determination has been made, and no assertion is made, as to whether any of the above might be applicable as prior art with regard to the present disclosure.

### SUMMARY

As described above, the authentication of the process may correspond to the method of verifying the electronic signature. If the execution file is large in size, a large amount of time may be taken for authentication of the corresponding process. Thus, a user may receive service with a significant delay of time. This may be a factor disabling a substantial service.

Aspects of the present disclosure are to address at least the above-mentioned problems and/or disadvantages and to provide at least the advantages described below. Accordingly, an aspect of the present disclosure is to provide a process authentication method and an electronic device implementing the same, which may provide swift process authentication, thereby enabling a substantial service, and improving an application quality in terms of usability. In particular, an aspect of the present disclosure is to provide a process authentication method and an electronic device implementing the same, which may provide swift process authentication after first authentication of a process, thereby reducing authentication time of the process.

In accordance with an aspect of the present disclosure, a method of authenticating a process of an electronic device is provided. The method includes receiving a message requesting authentication of the process, acquiring unique information of the process from an operating system of the process in response to the message requesting authentication of the process, comparing the acquired unique information with unique information previously stored in a memory, and determining that the authentication of the process has succeeded, when the acquired unique information coincides with the unique information previously stored.

In accordance with another aspect of the present disclosure, a method of authenticating a process of an electronic device is provided. The method includes receiving a message requesting authentication of the process, acquiring a setting value representing whether the process has already been authenticated, from a memory in response to the message requesting authentication of the process, acquiring unique information of the process from an operating system of the process when the setting value is a value representing that the process has already been authenticated, comparing the acquired unique information with unique information previously stored in the memory, and determining that the authentication of the process has succeeded, when the acquired unique information coincides with the unique information previously stored.

In accordance with another aspect of the present disclosure, a method of authenticating a process of an electronic device is provided. The method includes receiving a message requesting authentication of the process, accessing a memory and reading authentication setting information related to the process, in response to the message requesting authentication of the process, determining whether a first authentication scheme is used, with reference to the authentication setting information, acquiring unique information of the process from an operating system of the process when it is determined that the first authentication scheme is used, comparing the acquired unique information with unique information previously stored in the memory, and determining that the authentication of the process has succeeded, when the acquired unique information coincides with the unique information previously stored.

In accordance with another aspect of the present disclosure, a method of authenticating a process of an electronic device is provided. The method includes receiving a message requesting authentication of the process, accessing a memory and reading authentication setting information related to the process, in response to the message requesting authentication of the process, determining whether a first authentication scheme is used, with reference to the authentication setting information, acquiring, from the memory, a setting value representing whether the process has been already authenticated, when it is determined that the first authentication scheme is used, acquiring unique information of the process from an operating system of the process when the setting value is a value representing that the process has already been authenticated, comparing the acquired unique information with unique information previously stored in the memory, and determining that the authentication of the process has succeeded, when the acquired unique information coincides with the unique information previously stored.

In accordance with another aspect of the present disclosure, an electronic device is provided. The electronic device includes a user input unit, a memory including a process, an operating system of the process, and an authenticator that authenticates the process, and a processor that executes the process, the operating system, and the authenticator by accessing the memory and connects the user input unit and the memory. The authenticator receives a request for authentication of the process from the operating system, acquires unique information of the process from the operating system in response to the request of the operating system, compares the acquired unique information with unique information previously stored in the memory, and transmits a message representing that the authentication of the process has succeeded to the operating system when the acquired unique information coincides with the unique information previously stored.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description in conjunction with the accompanying drawings, in which:

FIG. 1 is a block diagram of a portable terminal according to an embodiment of the present disclosure;

FIG. 2 is a block diagram illustrating a software architecture of a portable terminal according to an embodiment of the present disclosure;

FIG. 3 is a block diagram illustrating a software architecture of a portable terminal according to an embodiment of the present disclosure;

FIG. 4 is a flowchart illustrating a process authentication method according to an embodiment of the present disclosure;

FIG. 5 is a flowchart illustrating a process authentication method according to an embodiment of the present disclosure;

FIG. 6 is a flowchart illustrating a process authentication method according to an embodiment of the present disclosure; and

FIG. 7 is a flowchart illustrating a process authentication method according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, an electronic device is a device having computing resources and may include, for example, a smart phone, a tablet Personal Computer (PC), a notebook PC, a digital camera, a computer monitor, a Personal Digital Assistant (PDA), an electronic organizer, a desktop PC, a Portable Multimedia Player (PMP), a media player (e.g., an MP3 player), an acoustic apparatus, a watch, a game terminal, a home appliance (e.g., a refrigerator, a Television (TV), a washing machine), and the like.

The electronic device according to the present disclosure may have a secure area and a normal area. Hardware (e.g., a memory, a Central Processing Unit (CPU), an Application Processor (AP), and the like) may be physically or logically divided into several areas, and one of the areas may correspond to the secure area. The secure area may include an operating system to which security techniques are applied, and hardware and software operating under the base of the operating system. Such a secure area may be safe from attacks including a memory dump, modulation, and the like. The normal area may be any one of hardware areas. The normal area may include a general operating system (e.g., Android, Linux, Windows, and the like), and hardware and software operating under the base of the operating system. The electronic device according to the present disclosure may have a shared area. The shared area may be utilized as a data transmission and/or reception path between the secure area and the normal area. For example, the shared area may include a shared memory.

In the present disclosure, an application is a subject to authentication, when a client requests authentication. The application includes all applications operating as a process while being loaded into a memory under the base of Linux, Android, Windows, and other operating systems. The application may be implemented with C, C++, Java, and all other types of languages. An authentication procedure is performed while the application is operating as a process. The application may exist in the normal area (i.e., one configuration of the normal area) or the secure area (i.e., one configuration of the secure area). Of course, the application may be configured with a plurality of modules, in which some of the modules may exist in the normal area and others may exist in the secure area.

In the present disclosure, a process information manager is a module for preserving (storing) and managing unique information of a process for authentication of an application. The process information manager may be included in the same application together with an authenticator, or may exist separately from the authenticator. The process information manager may exist in the normal area or the secure area.

In the present disclosure, the authenticator verifies whether a process is an authorized entity. Further, the authenticator may determine whether a general authentication scheme (e.g., an electronic signature, a Hash-based Message Authentication Code (HMAC), and the like) or a swift authentication scheme according to the present disclosure is to be used for process authentication. Here, ‘swift’ merely means that time taken for the authentication is relatively short as compared with the general authentication scheme (e.g., HMAC), and does not mean that the time taken for the authentication has an absolute value. The authenticator may include all applications operating on Linux, Android, Windows, and other operating systems, and may be implemented with C, C++, Java, and all other types of languages. The authenticator may exist in the normal area or the secure area. Meanwhile, a case in which a process needs to be authenticated will be exemplified as follow. When an application is loaded into a memory, the authenticator may verify whether the loaded application, i.e., the process is an authorized entity. The process (requester) may request a specific application (provider) to provide a specific function, through the operating system. Here, the provider may be a process or an unloaded application. The authenticator may verify whether the requester is authorized to use the corresponding function.

Hereinafter, a process authentication method and an electronic device according to the present disclosure will be described in detail. Terms and words used herein should not be construed as limited to typical or dictionary meanings, but should be construed as meanings and concepts coinciding with the spirit of the present disclosure. Accordingly, since the descriptions and the accompanying drawings are merely various embodiments of the present disclosure and do not represent all the spirits of the present disclosure, there may be various equivalents and modified embodiments capable of replacing them at the time of filing the present application. Further, in the accompanying drawings, some elements may be exaggerated, omitted, or schematically illustrated, and the size of each element may not precisely reflect the actual size. Accordingly, the present disclosure is not restricted according to a relative size or interval illustrated in the accompanying drawings. Detailed descriptions of well-known functions or configurations related to the present disclosure are omitted when they may make subject matters of the present disclosure unnecessarily obscure.

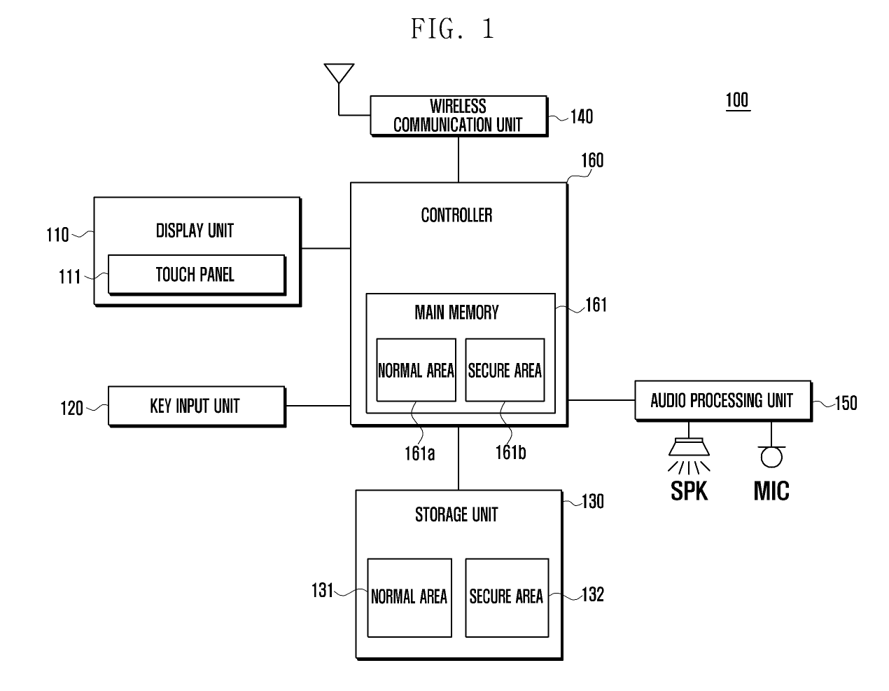

FIG. 1 is a block diagram of a portable terminal according to an embodiment of the present disclosure.

Referring to FIG. 1, the portable terminal 100 according to the embodiment of the present disclosure includes a display unit 110, a key input unit 120, a storage unit 130, a wireless communication unit 140, an audio processing unit 150, a speaker SPK, a microphone MIC, and a controller 160.

The display unit 110 displays data on a screen under control of the controller 160. Ehen the controller 160 processes (e.g., decodes) data and stores the processed data in a buffer, the display unit 110 may convert the data stored in the buffer to an analog signal and display the converted data on the screen. When power is supplied to the display unit 110, the display unit 110 may display a locking image on the screen. When unlocking information is detected while the locking image is being displayed, the controller 160 releases the lock. The display unit 110 may display a home image instead of the locking image under the control of the controller 160. The home image may include a background image (e.g., a photo set by a user) and a plurality of icons displayed thereon. Here, the respective icons indicate applications or content (e.g., a photo file, a video file, a recorded file, a document, a message, and the like). When one of the icons is, for example, an icon of a memo application is touched by a touch input device, the display unit 110 may display a memo pad under the control of the controller 160.

The display unit 110 may be configured with a Liquid Crystal Display (LCD), an Active Matrix Organic Light Emitted Diode (AMOLED), a flexible display, or a transparent display.

A touch panel 111 is a touch screen provided on the screen of the display unit 110. Specifically, the touch panel 111 is implemented as an add-on type device in which the touch panel 111 is located on the screen of the display unit 110, or an on-cell type or in-cell type in which the touch panel 111 is inserted into the display unit 110.

The touch panel 111 may generate a touch event in response to a user's gesture on the screen, and convert a touch event from analog to digital in order to transfer the converted digital signal to the controller 160. The touch event includes at least one touch coordinate (x, y). For example, a touch Integrated Circuit (IC) of the touch panel 111 detects a user's touch, determines a touch area in response to the touch, and transfers a touch coordinate (x, y) of the touch area to the controller 160. The touch panel 111 may be a complex touch panel including a hand touch panel that detects a hand gesture and a pen touch panel that detects a pen gesture. The hand touch panel is configured as a capacitive type. Of course, the hand touch panel may also be configured as a resistive type, an infrared type, or an ultrasonic wave type. The hand touch panel may generate a touch event not only by a user's hand gesture, but also by another object (e.g., a conductive object capable of causing a change in electrostatic capacity). The pen touch panel may be configured as an electromagnetic induction type. Accordingly, the pen touch panel may generate a touch event by a pen for a touch that is specially manufactured to form a magnetic field.

The key input unit 120 may generate a key event related to user settings and function control of the portable terminal 100 and transfers the key event to the controller 160. The key event may include a power on/off event, a volume control event, a screen on/off event, a shutter event, and the like. The controller 160 may control the aforementioned configurations in response to the key event.

The storage unit 130 may correspond to a disk, a Random Access Memory (RAM), a Read Only Memory (ROM), or a flash memory. Particularly, the storage unit 130 may be configured with a normal area 131 and a secure area 132. The normal area 131 may be designed to be physically isolated from the secure area 132. The secure area 132 may be used as an area where an operating system or applications of the normal area 131 cannot arbitrarily access. The normal area 131 may also be referred to as an unsecured area as a relative concept to the secure area 132. Meanwhile, the normal area 131 may also be referred to as a main area in a concept that a main operating system of the corresponding terminal and applications operating under the basis of the main operating system are installed. The secure area 132 may also be relatively referred to as a sub-area. Hereinafter, for convenience of descriptions, ‘normal’, ‘main’, and ‘unsecured’ are commonly referred to as ‘normal’. Further, ‘secure’ and ‘sub’ are commonly referred to as ‘secure’.

The normal area 131 may be configured with a normal program area and a normal data area. The normal program area may store a booting program, a normal operating system, and one or more applications (hereinafter, referred to as a normal application) operating under the base of the normal operating system. The applications in the normal area may be classified into an embedded application and a 3rd party application. For example, the embedded application includes a web browser, an e-mail program, an instant messenger, and the like. When power of a battery is supplied to the portable terminal 100, the booting program is first loaded into the main memory of the controller 160. The booting program loads the normal operating system in the main memory. For example, Android, Windows, iOS, or the like may be employed for the normal operating system of the present disclosure. The normal data area may store data generated by the normal operating system and the normal applications, data needed for execution of the normal operating system and the normal applications, and data received from an external device (e.g., a server, a desktop PC, a tablet PC, or the like) through the wireless communication unit 140.

The secure area 132 may be configured with a secure program area and a secure data area. The normal operating system or the normal applications cannot access the secure area 132, particularly, the secure data area. The secure program area may store a secure operating system, one or more applications (hereinafter, referred to as secure applications) operating under the basis of the secure operating system, and an operating system monitor. Mobicore of Gieseke & Devrient (G&D) may be employed for the secure operating system of the present disclosure. Such a secure operating system may be loaded into the main memory under the control of the normal operating system. Alternatively, the secure operating system may also be loaded into the main memory by the booting program. The Mobicorre is a secure product enabling users to safely perform internet banking, electronic payment, and the like through the portable terminal. The secure applications may be classified into an embedded application and a 3rd party application. The operating system monitor serves as an interface between the normal operating system and the secure operating system. For example, TrustZone technique of Advance RISC Machine (ARM) may be employed for the operating system monitor of the present disclosure. The secure data area may store data generated by the secure operating system and the secure applications, data needed for execution of the secure operating system and the secure applications, and data received from the external device through the wireless communication unit 140 by the secure operating system and the secure applications. Hereinafter, for convenience of descriptions, the data in the normal data area is referred to as ‘normal data’ and the data in the secure data area is referred to as ‘secure data’.

It is possible to access the secure data only by the secure operating system, the secure applications, and the operating system monitor, and it is impossible to access the secure data via the normal area. The normal operating system or the normal applications in the normal area cannot directly access the secure data, and may access the secure data only through the operating system monitor. Accordingly, the secure data may be safely protected from an unauthorized entity (e.g., a hacking program). For example, the secure data may include unique information (e.g., a Process unique identifier (PID)) of a process, a path name, process start time, and a start address of a stack. Here, although the PID is updated whenever the corresponding process is started (e.g., the corresponding process is loaded into the main memory 161), the PID of the started process may be an invariable value. The path name is a value representing a full path (e.g., C:\Program files\Office) of a corresponding application and may not vary as long as a user does not change the path name. The process start time may also not vary until the corresponding process is restarted (reloaded). The start address of the stack is a value representing the lowest address (i.e., a stack start address) among stack addresses of the corresponding process. Although the start address of the stack is updated whenever the corresponding process is started, the start address of the stack for the started process may not vary until the corresponding process is terminated (e.g., deleted from the main memory 161). In other words, the start address of the stack is stack for the lifetime of the process.

The aforementioned values may not vary while the corresponding process is loaded into the main memory 161. Accordingly, the aforementioned values may be used as the unique information of the corresponding process. In addition to the aforementioned values, any values that do not vary while the corresponding process is loaded may be used as the unique information of the corresponding process.

The storage unit 130 may include a process information manager and an authenticator.

The process information manager may store and manage unique information of a process. A storage place is referred to as a session cache. Such a session cache may be a part of the storage unit 130, a part of the main memory 161, or a part of a separate memory (e.g., a cache memory). When a process is terminated, the process information manager may delete the corresponding unique information from the session cache. The session cache may include a flag bit. The flag bit is a value representing whether a process has previously been authenticated. For example, when the flag bit is a value representing ‘true’, this means that the corresponding process has previously been authenticated. On the other hand, when the flag bit is a value representing ‘false’, this means that the corresponding process has not been authenticated or the authentication of the process failed.

The authenticator verifies whether an application loaded into the memory 161 is an authorized entity. For example, the authenticator verifies that process running the application is authenticated. When an application is loaded into the main memory 161, the authenticator may verify whether the corresponding process is an authorized entity, by using a general authentication scheme. When the process authentication succeeds, the authenticator reads, from the storage unit 130, a setting value representing whether a swift authentication scheme is to be used. For example, when the setting value corresponds to ‘true’, the authenticator commands (controls) the manager to store unique information of the corresponding process in the session cache. Alternatively, the authenticator may also directly store the unique information in the session cache. Further, when the process authentication succeeds, the authenticator controls the manager to set the flag bit to ‘true’. Alternatively, the authenticator may also directly set the flag bit to ‘true’.

When verifying a process, the authenticator may determine with reference to a setting value whether a general authentication scheme (e.g., comparison and authentication between an electronic signature and F (an execution file)) or a swift authentication scheme is to be used. As an example, when a process (requester) requests a specific application to provide a specific function, the authenticator may determine with reference to the setting value whether the swift authentication scheme is to be used. When the setting value corresponds to ‘true’, the authenticator verifies the requester by using the swift authentication scheme.

Meanwhile, a boolean indication of the swift authentication scheme may be set for each application. An example of the setting method for each application is as follows. The storage unit 130 may store a list of authentication target applications. Here, the list is differentiated into applications for which the swift authentication scheme is used and applications for which the swift authentication scheme is not used. When an application is loaded into the main memory 161, the authenticator stores a setting value representing whether the swift authentication scheme is to be used for the corresponding application, in the session cache. When process authentication is needed, the authenticator determines the use or not of the swift authentication scheme with reference to the corresponding setting value stored in the session cache.

More specific examples of the authenticator operation will be described below with reference to flowcharts.

The wireless communication unit 140 performs a voice call, a video call, or data communication with an external device through a network under the control of the controller 160. The wireless communication unit 140 includes a radio frequency transmitter up-converting and amplifying a frequency of a transmitted signal and a radio frequency receiver low-noise amplifying and down-converting a frequency of a received signal. Further, the wireless communication unit 140 may include a mobile communication module (e.g., a 3-Generation mobile communication module, a 3.5-Generation mobile communication module, 4-Generation mobile communication module, or the like), a digital broadcasting module (e.g., a Digital Multimedia Broadcasting (DMB) module), and a short distance communication module (e.g., a Wi-Fi module, a Bluetooth module, and a Near Field Communication (NFC) module).

The audio processing unit 150 combines with the speaker SPK and the microphone MIC, and performs an input and/or an output of an audio signal (e.g., speech data) for speech recognition, speech recording, digital recording, and a telephone call. The audio processing unit 150 may receive an audio signal from the controller 160, convert the received audio signal into an analog signal, amplify the analog signal, and output the amplified signal to the speaker SPK. The audio processing unit 150 converts an audio signal received from the microphone MIC into a digital signal and provides the digital signal to the controller 160. The speaker SPK converts the audio signal received from the audio processing unit 150 into a sound wave and outputs the sound wave. The microphone MIC converts a sound wave transferred from people or other sound sources into an audio signal.

The controller 160 controls an overall operation of the portable terminal 100 and signal flows between the internal configurations of the portable terminal 100, performs a data processing function, and controls power supply from the battery to the aforementioned configurations.

The controller 160 may be configured with one or more CPUs. As well known in the art, the CPU is an important control unit of a computer system that performs operation and comparison of data, interpretation and execution of commands, and the like. The CPU includes various resisters temporarily storing data or commands. The controller 160 may further include one or more Graphic Processing Units (GPUs). The GPU is a graphic control unit that performs operation and comparison of graphic related data, interpretation and execution of commands, and the like instead of the CPU. The CPU and GPU may be integrated into a single package in which two or more independent cores (e.g., a quad-core) are formed as a single integrated circuit. CPUs may be integrated into a single multi-core processor. Further, a plurality of GPUs may be integrated into a single multi-core processor. Further, the CPU and the GPU may be a System on Chip (SoC). Further, the CPU and GPU may be packaged in a multi-layer structure. Meanwhile, a configuration including the CPU and the GPU may be referred to as an Application Processor (AP). In the controller 160, at least one of the CPUs may be a CPU of the secure area. Further, in the controller 160, at least one of the GPUs may be a GPU of the secure area. Further, in the controller 160, at least one of the APs may be an AP of the secure area.

The controller 160 may further include the main memory 161, for example, the RAM. The CPU, the GPU, and the AP of the controller 160 may access the main memory 161 to read various programs and data loaded into the main memory 161, decipher commands of the read program, and execute a function according to the deciphered result. The main memory 161 stores various programs loaded from the storage unit 130, for example, a booting program, operating systems, an operating system monitor, and applications. Particularly, the main memory 161 may be configured with a normal area 161a and a secure area 161b to correspond to the storage unit 130. A booting program, a normal operating system, normal applications, and normal data may be loaded into the normal area 161a of the main memory 161. A secure operating system, secure applications, and secure data may be loaded into the secure area 161b of the main memory 161.

Although all modifications cannot be listed due to diversity thereof, depending on a convergence trend of a digital device, the portable terminal 100 may further include unmentioned configurations such as a camera, an acceleration sensor, a Global Positioning System (GPS) module, a vibration motor, an accessory, an ear jack, and the like. The accessory is a component of the portable terminal 100 that may be separated from the portable terminal 100 and may be, for example, a pen for a touch.

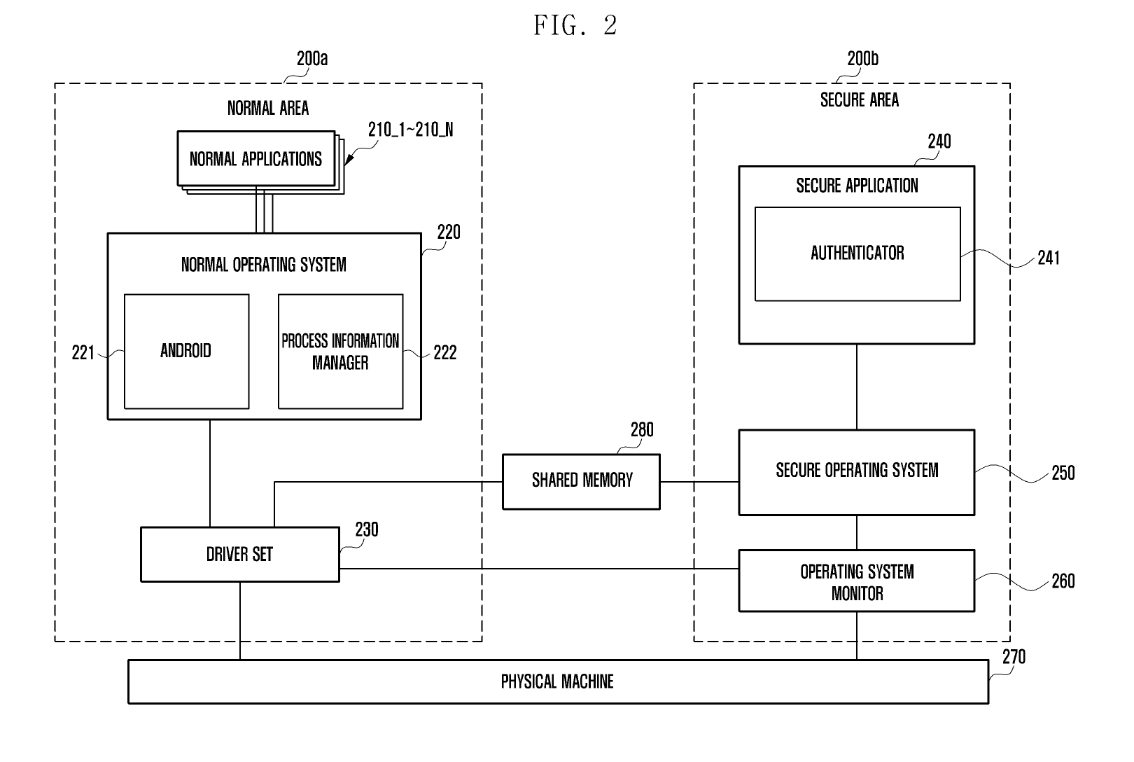

FIG. 2 is a block diagram illustrating a software architecture of a portable terminal according to an embodiment of the present disclosure.

Referring to FIGS. 1 and 2, a normal area 200a is configured with normal applications 210_1 to 210_N, a normal operating system 220, and a driver set 230, which are loaded from a storage unit 130. A secure area 200b is configured with a secure application 240, a secure operating system 250, and an operating system monitor 260, which are loaded from the storage unit 130.

The driver set 230 is above a physical machine 270 (e.g., a CPU and an AP) in a hierarchical structure. The driver set 230 serves as an interface between the normal operating system 220 and the physical machine 270. Further, the driver set 230 serves as an interface between the operating system monitor 260 and the physical machine 270. Moreover, the driver set 230 serves as an interface between the normal operating system 220 and the operating system monitor 260.

The driver set 230 includes peripheral device drivers. The peripheral device drivers may be configured with, for example, a touch panel driver, a wireless communication driver, a key input driver, an audio processing unit driver, and a display unit driver. The peripheral device drivers receive commands from the normal operating system 220 and/or the secure operating system 250 through the monitor 260, and controls inputs and/or outputs of a corresponding peripheral device in response to the commands.

The normal operating system 220, the secure operating system 250, and the operating system monitor 260 are above the driver set 230 in the hierarchical structure. The normal operating system 220 may be a main operating system of the portable terminal 100. The normal operating system 220 may include, for example, Android 221. Further, the normal operating system 220 may include a configuration for storing and managing unique information of a process, i.e., a process information manager 222.

The secure operating system 250 may be a sub-operating system of the portable terminal 100. For example, the secure operating system 250 may include Mobicore. The operating system monitor 260 serves as an interface between the operating systems. For example, TrustZone of Advance RISC Machine (ARM) may be included in the operating system monitor 260 of the present disclosure. Meanwhile, the operating system monitor 260 may include a second driver set. Accordingly, an interface between the secure operating system 250 and the physical machine 270 may be included in the second driver set of the operating system monitor 260.

In the hierarchical structure, the normal applications 210_1 to 210_N are hierarchically above the normal operating system 220, and the secure application 240 is hierarchically above the secure operating system 250. The secure application 240 may include an authenticator 241.

The authenticator 241 may be loaded into the secure area 200b only when authentication of a process is needed, and the execution of the authenticator 241 may be terminated when the process is completely authenticated. When the process is completely authenticated, the authenticator 241 may be deleted from the secure area 200b. Further, unique information of the process may be stored in the secure area 200b while the authenticator 241 is being executed. If the process is stored in the secure area 200b while the authenticator 241 is being executed, although the process is maintained, the unique information may be deleted without being maintained in the secure area 200b due to the termination of the authenticator 241. Accordingly, the authenticator 241 may be substituted by the aforementioned process information manager 222 for maintenance of the unique information.

The authenticator 241 may also be one module configuring the secure operating system 250. If the authenticator 241 is configuring the secure operating system 250, as long as the secure operating system 250 is not terminated, the authenticator 241 is also not terminated. Accordingly, the authenticator 241 may continuously reside in the secure area 200b irrespective of whether the process is completely authenticated. Further, the process unique information may also be continuously maintained in the secure area 200b irrespective of whether the process is completely authenticated.

A shared memory 280 exists between the normal area 200a and the secure area 200b. The shared memory 280 may be a part of the main memory 161. Further, the shared memory 280 may also be a part of the storage unit 130. Moreover, the shared memory 280 may also be a separate cache memory.

The software architecture as described above may operate as follows.

When an application is loaded into the normal area 200a or the secure area 200b, the corresponding operating system requests authentication of the normal application loaded into the corresponding area from the authenticator 241. The authenticator 241 may perform a general authentication scheme (e.g., a hash based authentication scheme). When the authentication (e.g., the hash based authentication) succeeds by the authenticator 241, the process information manager 222 stores, in the memory, unique information of the process for which the authentication has succeeded. Further, the process information manager 222 may set a flag bit of the process for which the authentication has succeeded to ‘true’. When the process (i.e., the application loaded into the normal area 200a or secure area 200b) requests data or a certain specific function from the corresponding operating system, the operating system requests the authenticator 241 to authenticate the process. The authenticator 241 may execute the swift authentication scheme. The authenticator 241 may request unique information of the process from a kernel of the corresponding operating system, and accesses the memory to read out the unique information of the corresponding process, in response to the request for the process authentication. The authenticator 241 may compare the two pieces of unique information, and transfer authentication success of the corresponding process to the corresponding operating system when the two pieces of unique information coincide with each other. When the authentication of the process has succeeded as described above, the corresponding operating system accepts the request of the process. If the two pieces of unique information do not coincide with each other (i.e., the swift authentication fails), the authenticator 241 may delete all information related to the corresponding process in the memory, and executes the general authentication scheme.

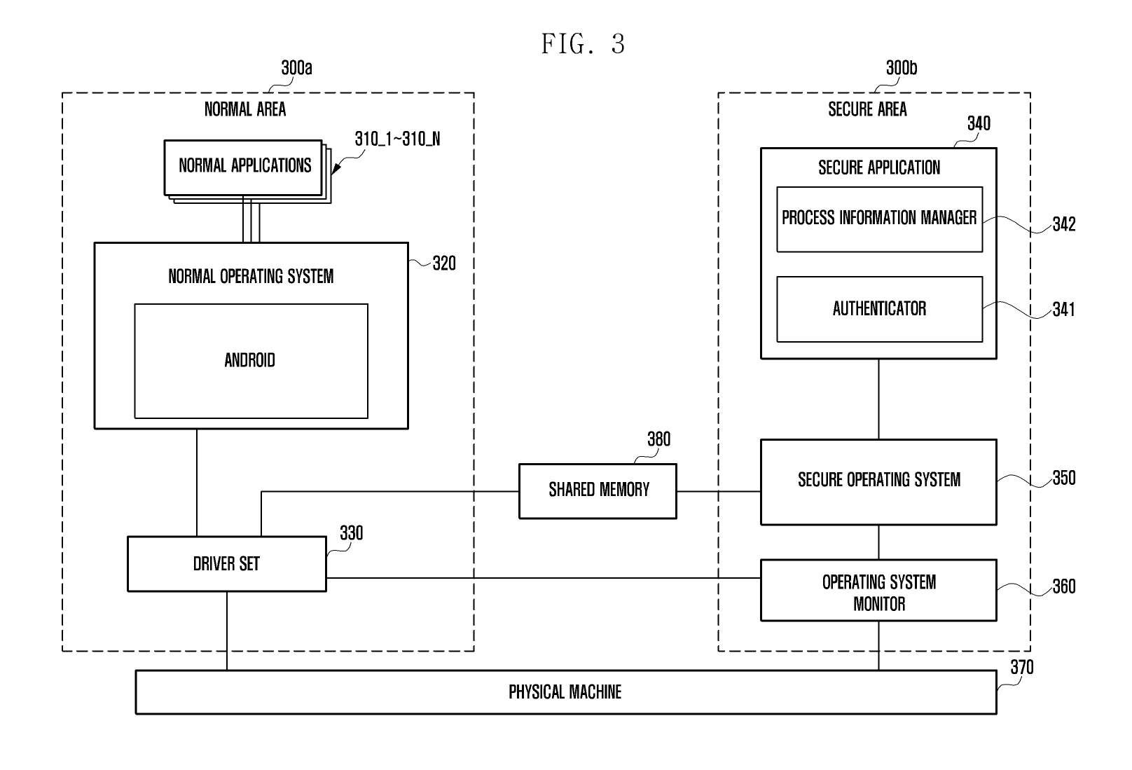

FIG. 3 is a block diagram illustrating a software architecture of a portable terminal according to an embodiment of the present disclosure. In describing FIG. 3, a description of contents identical with the aforementioned ones will be omitted.

Referring to FIGS. 1 and 3, a normal area 300a is configured with normal applications 310_1 to 310_N, a normal operating system 320, and a driver set 330, which are loaded from a storage unit 130. The driver set 330 serves as an interface between the normal operating system 320 and the physical machine 370. A secure area 300b is configured with a secure application 340, a secure operating system 350, and an operating system monitor 360, which are loaded from the storage unit 130.

A process information manager 342 may be one module configuring the secure application 340 together with an authenticator 341. The authenticator 341 and the process information manager 342 may also be separate applications, respectively. Further, the process information manager 342 may also be one module configuring the secure operating system 350. Moreover, the authenticator 341 may also be one module configuring the secure operating system 350. The swift authentication scheme of the present disclosure may be performed by the secure operating system 350. Although security would be relatively weak, the swift authentication scheme of the present disclosure may also be performed in the normal area 300a.

A shared memory 380 exists between the normal area 300a and the secure area 300b. The shared memory 380 may be a part of the main memory 161. Further, the shared memory 380 may also be a part of the storage unit 130. Moreover, the shared memory 380 may also be a separate cache memory.

Hereinafter, it is assumed that a software architecture that is a basis of the process authentication scheme corresponds to the example illustrated in FIG. 2. Of course, the spirit of the present disclosure is not limited to the example illustrated in FIG. 2. The process authentication scheme of the present disclosure may be based on the example illustrated in FIG. 3, and is available even in a software architecture without the secure area 300b.

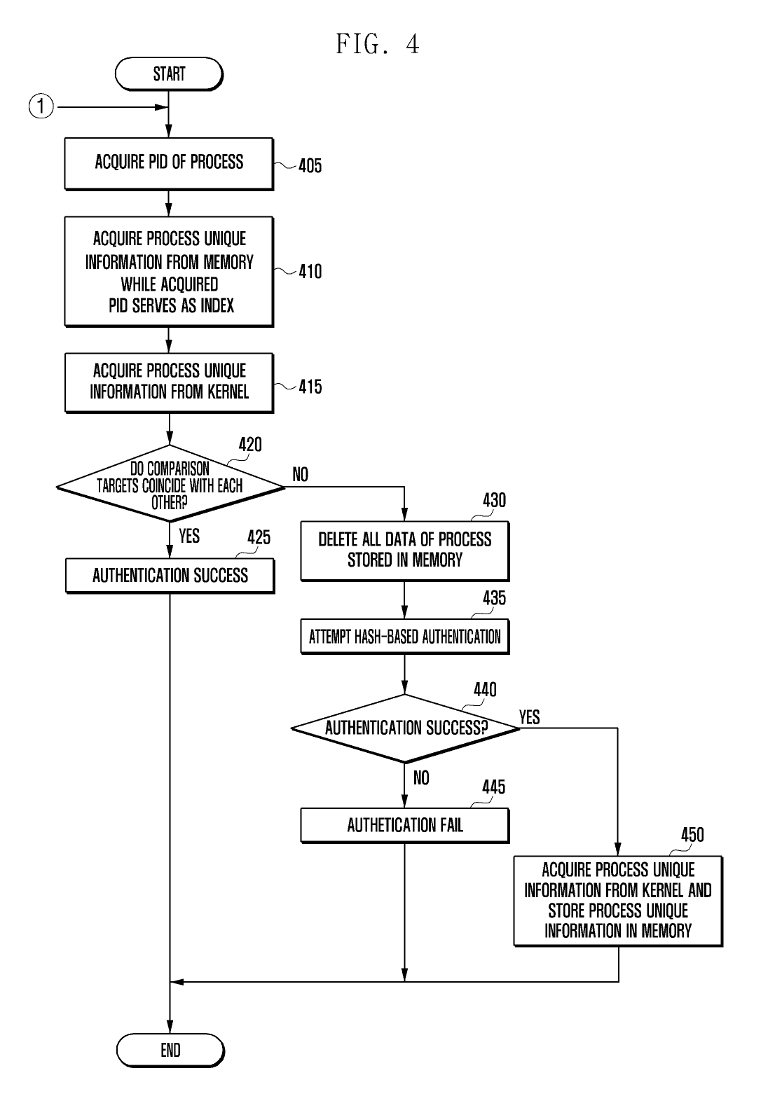

FIG. 4 is a flowchart illustrating a process authentication method according to an embodiment of the present disclosure.

Referring to FIG. 4, a normal application 210_1 requests a normal operating system 220 to provide a specific function of a normal application 210_2. The normal operating system 220 makes a request for authentication of the normal application 210_1 to an authenticator 241. A request message of the normal operating system 220 is transferred to the authenticator 241 through a driver set 230, a monitor 260, and a secure operating system 250.

The authenticator 241 may acquire a PID of the process (i.e., the normal application 210_1) in response to the authentication request, in operation 405. There may be various acquisition methods. As an example, the authenticator 241 may transfer a message making a request for providing the PID of the corresponding process, to a kernel of Android 221 through the interfaces 250, 260, and 230. The kernel may acquire the PID through, for example, a socket (a type of function for calling the corresponding process) of the corresponding process or a path name of the corresponding process. The kernel of Android 221 transmits a response message containing the acquired PID to the authenticator 241.

In operation 410, the authenticator 241 may acquire process unique information of the normal application 210_1 from a memory (a session cache), with the PID acquired from the kernel serving as an index. The memory may be a part of a main memory 161, a part of a storage unit 130, or a separate cache memory. Further, the memory (session cache) storing the process unique information may be one of configurations of the secure area, or one of configurations of the normal area. The authenticator 241 may access the memory (session cache) to read out the process unique information. Further, the authenticator 241 may also transmit the request message containing the PID to a process information manager 222. In response to that, the process information manager 222 reads the process unique information corresponding to the PID from the memory, and transfers a response message containing the process unique information to the authenticator 241.

In addition to the process unique information, verification information for verifying the process unique information may be further included in the memory. The verification information is created separately from and stored together with the process unique information when the corresponding unique information is stored in the memory. A subject of the creation may be the authenticator 241 or the process information manager 222. For example, the verification information may be an H(PID), an H(PID⊙path name⊙process start time), an H(PID⊙secret key), and the like. The H( ) is an arbitrary function. For example, the H( ) may be a hash function. ⊙ is an arbitrary operation. For example, ⊙ may be an XOR operation, a concatenation operation, or the like. The secret key is a confidential key known by only the subject of the creation.

The authenticator 241 may directly access the memory (session cache) to read out the verification information together with the process unique information. Further, when the authenticator 241 requests a request message containing the PID from the process information manager 222, the process information manager 222 may also read process unique information corresponding to the PID and the verification information from the memory (session cache), and may transfer a response message containing the process unique information and the verification information to the authenticator 241.

In operation 415, the authenticator 241 may acquire, from the kernel of Android 221, unique information of a second process corresponding to unique information of a first process acquired from the memory. For example, when process start time has been acquired from the memory, process start time will also be accordingly acquired from the kernel.

In operation 420, the authenticator 241 may compare the unique information of the first process acquired from the memory with the unique information of the second process acquired from the kernel. Additionally, in operation 420, the authenticator 241 may create verification information by using the unique information of the first process acquired from the memory. Further, in operation 420, the authenticator 241 may also compare first verification information acquired from the memory with second verification information directly created thereby.

In operation 420, when the comparison targets coincide with each other, the authenticator 241 may transfer a message representing that the authentication has succeeded to the corresponding operating system (namely, the normal operating system 220), in operation 425. Accordingly, the normal operating system 220 may provide the function requested according to the normal application 210_1 to the normal application 210_1.

In operation 420, when the comparison targets do not coincide with each other, the authenticator 241 may delete all data of the corresponding process stored in the memory, in operation 430. The authenticator 241 may directly delete the data of the corresponding process by controlling the corresponding memory. The authenticator 241 may also transmit a message for requesting the process information manager 222 to delete the data. In operation 435, the authenticator 241 may authenticate the normal application 210_1 by using a general authentication scheme (e.g., a hash based authentication scheme or another authentication scheme). In operation 440, the authenticator 241 may determine whether the authentication has succeeded. When the authentication has failed, the authenticator 241 may transfer a message representing that the authentication has failed to the normal operating system 220, in operation 445. Accordingly, the normal operating system 220 rejects the function requested according to the normal application 210_1. When the authentication has succeeded, the authenticator 241 may acquire process unique information of the normal application 210_1 from the kernel of Android 221, in operation 450. The authenticator 241 may store the acquired process information in the memory such that the swift authentication may be made later.

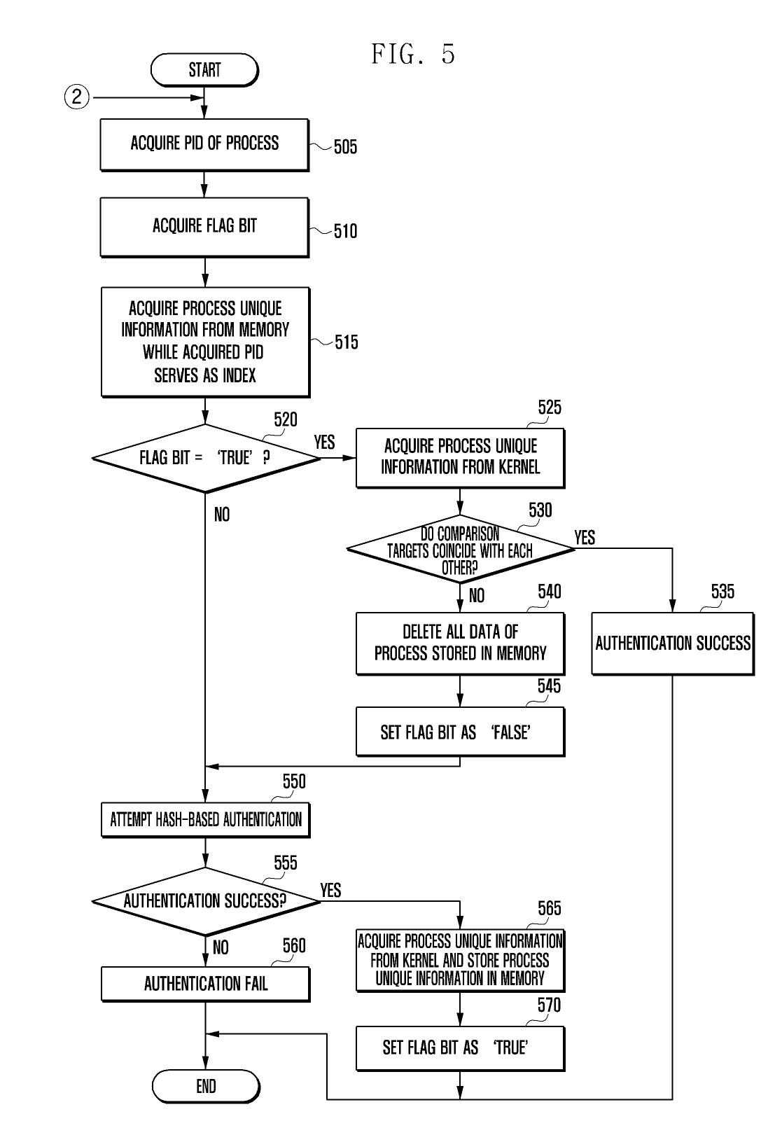

FIG. 5 is a flowchart illustrating a process authentication method according to an embodiment of the present disclosure. In describing FIG. 5, contents identical with those in FIG. 4 may be omitted.

Referring to FIG. 5, a normal application 210_1 requests a normal operating system 220 to provide a specific function of a normal application 210_2. The normal operating system 220 makes a request for authentication of the normal application 210_1 to an authenticator 241.

The authenticator 241 may acquire a PID of the process (i.e., the normal application 210_1) in response to the authentication request, in operation 505. Further, the authenticator 241 may acquire a flag bit of the normal application 210_1 from a memory, with the acquired PID serving as an index, in operation 510. Further, the authenticator 241 may acquire process unique information of the normal application 210_1 from the memory, with the acquired PID serving as an index, in operation 515. Operations 510 and 515 may be simultaneously performed. For example, the authenticator 241 may access the memory to read out the flag bit and the process unique information. Further, the authenticator 241 may also transmit a request message containing the PID to a process information manager 222. In response to the request to the process information manager 222, the process information manager 222 may read the flag bit and the process unique information corresponding to the PID from the memory, and transfers a response message containing the flag bit and the process unique information to the authenticator 241.

In operation 520, the authenticator 241 may identify whether the flag bit corresponds to ‘true’ (i.e., whether the corresponding process has been already authenticated).

In operation 520, when the flag bit corresponds to ‘true’, the authenticator 241 may acquire process unique information from a kernel of Android 221, in operation 525. Meanwhile, operation 515 may also be performed when the flag bit corresponds to ‘true’. When the flag bit corresponds to ‘true’, the authenticator 241 may acquire the process unique information of the normal application 210_1 from the memory, and may acquire the process unique information from the kernel of Android 221.

In operation 530, the authenticator 241 may compare unique information of a first process acquired from the memory with unique information of a second process acquired from the kernel. Additionally, in operation 530, the authenticator 241 may create verification information by using the unique information of the first process acquired from the memory. Further, in operation 530, the authenticator 241 may also compare first verification information acquired from the memory with second verification information directly created thereby.

In operation 530, when the comparison targets coincide with each other, the authenticator 241 may transfer a message representing that the authentication has succeeded to the corresponding operating system (i.e., the normal operating system 220), in operation 535. Accordingly, the normal operating system 220 may provide the function requested according to the normal application 210_1 to the normal application 210_1.

In operation 530, when the comparison targets do not coincide with each other, the authenticator 241 may delete all data of the corresponding process stored in the memory, in operation 540. The authenticator 241 may set the flag bit of the corresponding process, (i.e., the normal application 210_1) to ‘false’, in operation 545. In operation 550, the authenticator 241 may authenticate the normal application 210_1 by using a general authentication scheme (e.g., a hash based authentication scheme or another authentication scheme). In operation 555, the authenticator 241 may determine whether the authentication has succeeded. When the authentication has failed, the authenticator 241 may transfer a message representing that the authentication has failed to the normal operating system 220, in operation 560. Accordingly, the normal operating system 220 rejects the function requested according to the normal application 210_1. In operation 555, when the authentication has succeeded, the authenticator 241 may acquire process unique information of the normal application 210_1 from the kernel of Android 221, in operation 565. The authenticator 241 may store the acquired process information in the memory such that the swift authentication may be made later. Further, the authenticator 241 may set the flag bit of the normal application 210_1 to ‘true’, in operation 570.

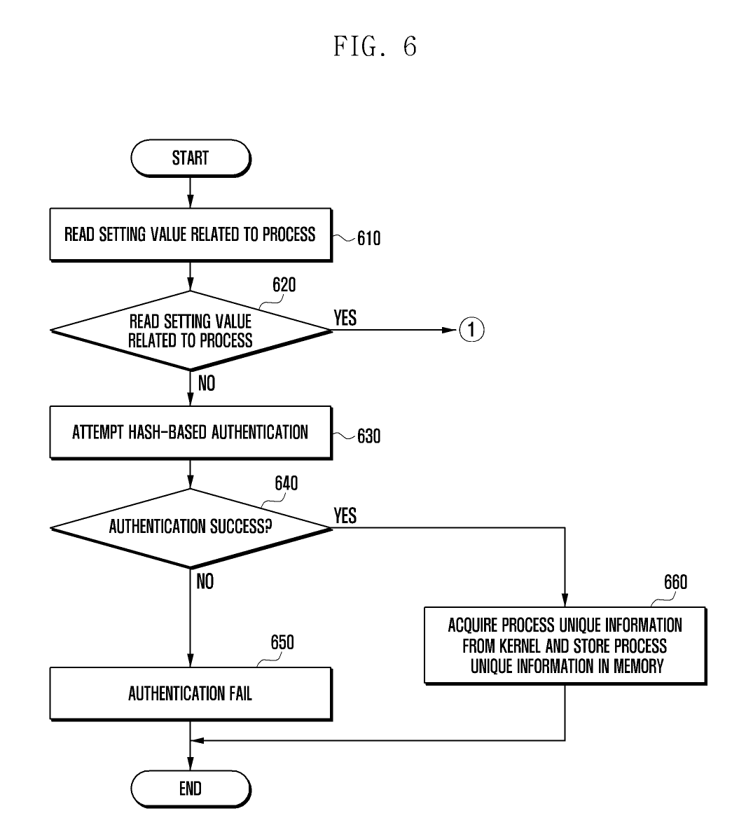

FIG. 6 is a flowchart illustrating a process authentication method according to an embodiment of the present disclosure. In describing FIG. 6, contents identical with those in FIGS. 4 and 5 may be omitted.

Referring to FIG. 6, a normal application 210_1 requests a normal operating system 220 to provide a specific function of a normal application 210_2. The normal operating system 220 makes a request for authentication of the normal application 210_1 to an authenticator 241.

In response to the authentication request, the authenticator 241 may access a storage unit 130 and read out authentication setting information related to the normal application 210_1, in operation 610. The authentication setting information may include a setting value representing whether a swift authentication scheme is to be used in authentication of the normal application 210_1. In operation 620, the authenticator 241 may determine, with reference to the authentication setting information, whether the swift authentication scheme is to be used. In operation 620, when it is determined that the swift authentication scheme is to be used, the aforementioned procedures of FIG. 4 may be performed via connector 1.

In operation 620, when it is determined that the swift authentication scheme is not to be used, the authenticator 241 may authenticate the normal application 210_1 by using a general authentication scheme (e.g., a hash-based authentication scheme or another authentication scheme), in operation 630.

In operation 640, the authenticator 241 may determine whether the authentication has succeeded. When the authentication has failed, the authenticator 241 may transfer a message representing that the authentication has failed to the normal operating system 220, in operation 650. Accordingly, the normal operating system 220 rejects the function requested according to the normal application 210_1. In operation 640, when it is determined that the authentication has succeeded, the authenticator 241 may acquire the process unique information of the normal application 210_1 from a kernel of Android 221, in operation 660. The authenticator 241 may store the acquired process information in the memory such that the swift authentication may be made later.

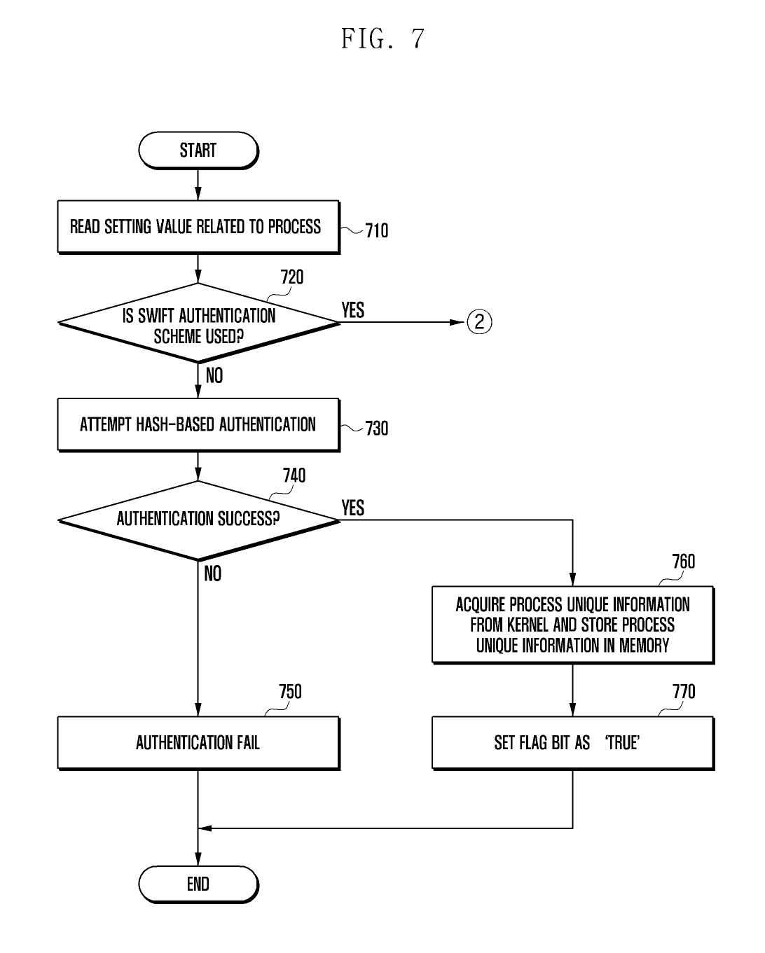

FIG. 7 is a flowchart illustrating a process authentication method according to an embodiment of the present disclosure. In describing FIG. 7, contents identical with those in FIGS. 4, 5, and 6 may be omitted.

Referring to FIG. 7, a normal application 210_1 requests a normal operating system 220 to provide a specific function of a normal application 210_2. The normal operating system 220 makes a request for authentication of the normal application 210_1 to an authenticator 241.

In response to the authentication request, the authenticator 241 may access a storage unit 130 and read out authentication setting information related to the normal application 210_1, in operation 710. In operation 720, the authenticator 241 may determine, with reference to the authentication setting information, whether a swift authentication scheme is to be used. When it is determined that the swift authentication scheme is to be used, the aforementioned procedures of FIG. 5 may be performed via connector 2.

In operation 720, when it is determined that the swift authentication scheme is not to be used, the authenticator 241 may authenticate the normal application 210_1 by using a general authentication scheme (e.g., a hash-based authentication scheme or another authentication scheme), in operation 730.

In operation 740, the authenticator 241 may determine whether the authentication has succeeded. When the authentication has failed, the authenticator 241 may transfer a message representing that the authentication has failed to the normal operating system 220, in operation 750. Accordingly, the normal operating system 220 rejects the function requested according to the normal application 210_1. In operation 740, when the authentication has succeeded, the authenticator 241 acquires the process unique information of the normal application 210_1 from a kernel of Android 221, in operation 760. The authenticator 241 may store the acquired process information in the memory such that the swift authentication may be made later. Further, the authenticator 241 may set a flag bit of the normal application 210_1 to ‘true’, in operation 770.

An attacker (e.g., a hacking program loaded into the normal area) may attempt the following attacks for the swift authentication scheme. When an attack target process is authenticated according to the swift authentication scheme, the attacker may counterfeit his own unique information with unique information of the attack target process. The attacker is likely to pass authentication from the authenticator, by disguising himself as the attacked target process. Accordingly, technologies for preventing forgery and alteration of unique information (for example, SELinux) may be applied to the operating system, the authenticator, and the like.

According to various embodiments of the present disclosure, the following advantages may be provided.

If there is a data storage module enabling secure data encoding/decoding for an application, each process (requester) is to be authenticated for use of the module. When a web browser utilizes the module to store cookies, it may be assumed in view of the general environment that the web browser of 10 MB reads/writes fifty cookies. If the general authentication scheme such as SHA-256 is used for authentication of the web browser, it may take, for example, 40 seconds to one minute to authenticate the web browser for data encoding/decoding of the fifty cookies. This is a level at which the web browser is almost impossible to use. However, according to various embodiments of the present disclosure, the swift authentication scheme may significantly reduce the time taken for the process authentication without deterioration of the strength of the security. In addition, when a technology for preventing forgery and alteration (e.g. SELinux) is applied to the swift authentication scheme, the deterioration of the security strength may be minimized. Consequently, the present disclosure provides an advantage that capability of computing resources may be maximized without security deterioration in an environment requiring repeated authentication of processes.

The method according to the present disclosure as described above may be implemented as program commands that may be performed through various computers, and may be recorded in a computer readable recording medium. The recording medium may include a program command, a data file, a data structure, and the like. Further, the program command may be specially designed and configured for the present disclosure, or may be well known to and used by those skilled in the computer software related art. Further, the recording medium may include a magnetic media such as a hard disk, a floppy disk, and a magnetic tape, an optical media such as a Compact Disk-Read Only Memory (CD-ROM) and a Digital Versatile Disk (DVD), a magneto-optical media such as a floptical disk, and a hardware device such as a ROM, a RAM, a flash memory, and the like. Furthermore, the program command may include not only a machine language code made by a compiler but also a high-level language code that may be executed by a computer using an interpreter. The hardware device may be configured to operate as one or more software modules for performance of the present disclosure.

The method and the device according to the present disclosure are not limited to the aforementioned embodiments, and various modified embodiments thereof may be made within the range allowed according to the technical spirits of the present disclosure.

While the present disclosure has been shown and described with reference to various embodiments thereof, it will be understood by those skilled in the art that various changes in form and details may be made therein without departing from the spirit and scope of the present disclosure as defined according to the appended claims and their equivalents.

What is claimed is:

1. A method of authenticating a process of an electronic device, the method comprising:
receiving a message requesting authentication of the process;
acquiring unique information of the process from an operating system of the process in response to the message requesting authentication of the process;
comparing the acquired unique information with unique information previously stored in a memory; and
determining that the authentication of the process has succeeded, when the acquired unique information coincides with the unique information previously stored.

2. The method of claim 1, wherein the acquiring of the unique information of the process comprises:
acquiring an identifier of the process from the operating system in response to the message requesting authentication of the process;
acquiring unique information of a first process from the memory, with the acquired identifier serving as an index; and
acquiring unique information of a second process corresponding to the unique information of the first process from the operating system.

3. The method of claim 1, further comprising:
deleting all data corresponding to the process stored in the memory, when the acquired unique information does not coincide with the unique information previously stored;
attempting authentication of the process by using a preset authentication scheme; and
acquiring the unique information of the process from the operating system and storing the unique information of the process in the memory, when the authentication using the preset authentication scheme succeeds.

4. The method of claim 1, wherein the unique information previously stored in the memory is accessible from a secure area of the electronic device and is inaccessible from a normal area of the electronic device.

5. A method of authenticating a process of an electronic device, the method comprising:
receiving a message requesting authentication of the process;
acquiring a setting value representing whether the process has already been authenticated, from a memory in response to the message requesting authentication of the process;
acquiring unique information of the process from an operating system of the process when the setting value is a value representing that the process has already been authenticated;
comparing the acquired unique information with unique information previously stored in the memory; and
determining that the authentication of the process has succeeded, when the acquired unique information coincides with the unique information previously stored.

6. The method of claim 5, further comprising:
attempting authentication of the process according to a preset authentication scheme, when the setting value is not the value representing that the process has already been authenticated;
acquiring the unique information of the process from the operating system and storing the unique information of the process in the memory, when the authentication using the preset authentication scheme succeeds; and
setting the setting value as the value representing that the process has already been authenticated.

7. The method of claim 5, further comprising:
setting the setting value as a value representing that the process has not been authenticated, when the acquired unique information does not coincide with the unique information previously stored.

8. A method of authenticating a process of an electronic device, the method comprising:
receiving a message requesting authentication of the process;
accessing a memory and reading authentication setting information related to the process, in response to the message requesting authentication of the process;
determining whether a first authentication scheme is used, with reference to the authentication setting information;
acquiring unique information of the process from an operating system of the process when it is determined that the first authentication scheme is used;
comparing the acquired unique information with unique information previously stored in the memory; and
determining that the authentication of the process has succeeded, when the acquired unique information coincides with the unique information previously stored.

9. The method of claim 8, further comprising:
attempting authentication of the process by using a second authentication scheme when the acquired unique information does not coincide with the unique information previously stored.

10. A method of authenticating a process of an electronic device, the method comprising:
receiving a message requesting authentication of the process;
accessing a memory and reading authentication setting information related to the process, in response to the message requesting authentication of the process;
determining whether a first authentication scheme is used, with reference to the authentication setting information;
acquiring, from the memory, a setting value representing whether the process has been already authenticated, when it is determined that the first authentication scheme is used;
acquiring unique information of the process from an operating system of the process when the setting value is a value representing that the process has already been authenticated;
comparing the acquired unique information with unique information previously stored in the memory; and
determining that the authentication of the process has succeeded, when the acquired unique information coincides with unique information previously stored.

11. The method of claim 10, further comprising:
attempting authentication of the process according to a second authentication scheme when the setting value is a value representing that the process has not been authenticated or the acquired unique information does not coincide with the unique information previously stored.

12. An electronic device comprising:
a user input unit;
a memory comprising a process, an operating system of the process, and an authenticator that authenticates the process; and
a processor that executes the process, the operating system, and the authenticator by accessing the memory and connects the user input unit and the memory,
wherein the authenticator receives a request for authentication of the process from the operating system, acquires unique information of the process from the operating system in response to the request of the operating system, compares the acquired unique information with unique information previously stored in the memory, and transmits a message representing that the authentication of the process has succeeded to the operating system when the acquired unique information coincides with the unique information previously stored.

13. The electronic device of claim 12, wherein the authenticator acquires an identifier of the process from the operating system in response to the request of the operating system, acquires unique information of a first process from the memory, with the acquired identifier serving as an index, and acquires unique information of a second process corresponding to the unique information of the first process from the operating system.

14. The electronic device of claim 12, wherein the authenticator deletes all data of the process stored in the memory when the acquired unique information does not coincide with the unique information previously stored, attempts authentication of the process by using a preset authentication scheme, acquires the unique information of the process from the operating system when the authentication using the preset authentication scheme has succeeded, and stores the unique information of the process in the memory.

15. The electronic device of claim 12, wherein the unique information previously stored in the memory is accessible from the authenticator and is inaccessible from the process and the operating system.

16. The electronic device of claim 12, wherein the processor comprises at least one CPU or AP.

17. The electronic device of claim 12, wherein the user input unit comprises a touch screen.

18. The electronic device of claim 12, wherein the operating system receives a request to provide a specific function from the process, and transmits a message requesting authentication of the process to the authenticator in response to the request of the process.

19. The electronic device of claim 18, wherein the memory further comprises a second operating system of the authenticator that receives the message requesting the authentication of the process from the operating system and transfers the message to the authenticator.

20. At least one non-transitory processor readable medium for storing a computer program of instructions configured to be readable by at least one processor for instructing the at least one processor to execute a computer process for performing the method as recited in claim 1.
